(19) United States
(12) Patent Application Publication
(10) Pub. No.: US 2022/0065363 A1
(43) Pub. Date: Mar. 3, 2022

(54) Composite valve handle

(71) Applicants: David E. Sisk, Bonne Terre, MO (US); Peter Kemp, Crestwood, MO (US); Travis Kinneman, Fredricktown, MO (US); Andrew Boyer, Bonne Terre, MO (US)

(72) Inventors: David E. Sisk, Bonne Terre, MO (US); Peter Kemp, Crestwood, MO (US); Travis Kinneman, Fredricktown, MO (US); Andrew Boyer, Bonne Terre, MO (US)

(21) Appl. No.: 17/300,524

(22) Filed: Jul. 30, 2021

Related U.S. Application Data
(60) Provisional application No. 63/103,891, filed on Aug. 28, 2020.

(51) Int. Cl. F16K 31/60; F16K 35/02

(52) U.S. Cl. CPC F16K 31/602; F16K 35/025

(57) ABSTRACT

A composite handle assembly has a primary handle bar having a proximal end portion and a distal end portion, the primary handle bar having a first offset bend and a second offset bend and a step portion between the offset bends, the distal end having a cored head portion and a retaining tab, a handle plate having a retaining slot for receiving the retaining tab, a lock lever member having a proximal end portion and a distal end portion, the lock lever member having a first offset bend, a second offset bend, and a step portion between the offset bends, and a pivotal connection for connecting the lock lever member within the primary handle

### CROSS-REFERENCE TO RELATED APPLICATIONS

This regular letters patent application is a non-provisional patent application having Ser. No. 63/103,891, filed on Aug. 28, 2020.

### FIELD OF THE DISCLOSURE

This disclosure relates to a device for operating a butterfly valve of the type associated with a hopper tee positioned on a bottom of a bulk commodity tank or storage container for use in unloading contents of the tank or storage container, and more particularly, to a composite handle for controlling operation of the butterfly valve from a position remote from the butterfly valve. This disclosure also relates to a composite handle assembly to a butterfly valve, that is normally manually manipulated, that is positioned where it can be conveniently turned by the operator between its closed and discharging positions. In other words, this disclosure greatly facilitates the ability of one to manipulate a butterfly valve during its usage from a convenient position and location.

### BACKGROUND

Hoppers and tank trailers have been commonly used to transport bulk commodities such as granular product or dry bulk material, including industrial products and food products. The hoppers may include multiple sections or compartments for receiving and holding the commodities, with each section or compartment having a generally conical or tapered bottom portion terminating at a discharge outlet. A discharge valve, such as a butterfly valve, is typically provided at the discharge outlet and when opened will allow the commodities to flow out of the tank trailer.

When the hopper or the tank trailer reaches its destination, the bulk commodity will be unloaded by use of a pressurized air system. Typically, this is accomplished by connecting tee assemblies for unloading and then initiating the pneumatic unloading of the bulk commodity from the hopper into a clean and sanitary pipeline. In this manner, the tee assemblies are connected at opposite ends thereof to generally horizontal pipes or hoses that are connected, in turn, to the hopper tees of other sections or compartments. These connections establish a generally horizontal path through the hopper tees and connected pipes or hoses for the flow of the materials discharged from the hopper sections or compartments.

Actual transfer of the bulk commodity that has been transported in the hopper is then accomplished by opening the discharge or dump valve, typically a butterfly valve, associated with the discharge outlet at the bottom of the hopper. Once the valve is opened, the bulk commodity material is moved out of the hopper by gravity flow or by air pressure vibration into and through the vertical section of the hopper tee. As the bulk commodity material drains through the vertical section of the hopper tee into the horizontal portion of the hopper tee, the material is directionally directed through the horizontal portion by a pressure differential in the pipe to cause the material to be directed to and discharged to a desired receptacle or area.

The butterfly valve is generally configured to be manually operated by a rotatable valve stem that projects generally outwardly and generally horizontally near the top of the vertical section of the hopper tee. The valve stem may be engaged by a valve handle so as to be rotated by the operation of the valve handle to open and close the valve. Typically, the projecting portion of the valve stem has been formed or machined at its outer end to have a non-circular cross-section so as to be easily engaged by a similarly configured socket portion associated with the valve handle.

Because the discharge valve for the hopper is positioned at the bottom of the hopper, access to the valve for purposes of opening and closing the valve is often inconvenient. Due to the limited ground clearance height of the valve and the valve being generally centered below the hopper, the valve is difficult to easily reach. Further, a valve handle device must frequently be employed by an operator to assist in actuating the discharge valve. Use of the valve handle device puts the operator in awkward or less than desirable position. Consequently, over the years, it has become desirable, if not customary, for valve handle devices to be constructed from aluminum or other lighter weight materials so as to lessen the strain on the operator as the operator attempts to handle and utilize the valve handle device in awkward positions. Also, these handles may be retained in place on the discharge valve with set screws. Sometimes the set screws fall out and the handle can fall off and be lost. Other times the set screws corrode to the handle, due to the handles being constructed from dissimilar metals, and the set screws have to be cut from the handle and the discharge valve and replaced.

The butterfly valve is used at the base of tank trailers, or even railroad cars, as a means to prevent the untimely discharge of the conveying cargo, whether the cargo be grains, polymer beads, or other flowable materials. The butterfly valve may be manipulated into an open position to provide for the prompt discharge of material from the tank trailer or hopper. Usually, in order to gain access to the butterfly valve to operate the valve, the operator of the vehicle was required to climb under the tank trailer and in the early days, apply a wrench to the butterfly valve shaft, and forcefully turn it at least a quarter turn, in order to provide for opening or closing of the valve, during its manipulation and operation. The problem with such structure was its accessibility, because the operator was required to crawl deeply under the vehicle, to obtain access to the shaft, and to attain its manipulation, during use. During inclement weather, obviously, this is a dirty task, but, regardless of the weather, it was still predominantly a difficult task. Also, the butterfly valve is in close proximity to hot air supply lines that can reach temperatures of 350° F. If caution is not exercised, it is possible that the operator may be burned by coming into contact with the hot air supply lines.

Consequently, there has existed a need for an improved butterfly valve extension handle assembly that can be more easily operated by a user without encountering undue interference with other equipment or piping at the bottom on the hopper. It would also be desirable to avoid any potentially hazardous conditions such as coming into contact with hot air lines or being near a tremendous amount of material being discharged. It would also be advantageous to provide a composite handle assembly that is designed to enhance the safety and convenience of the vehicle operator, and to facilitate easy manipulation of a butterfly valve when unloading of a tank trailer. Further, there is a need to avoid any corrosion between the handle and the butterfly valve to eliminate the need to remove or cut the handle from the butterfly valve.

### SUMMARY OF THE DISCLOSURE

The present disclosure is directed to a composite handle assembly which comprises a primary handle bar having a proximal end portion and a distal end portion, the primary handle bar having a first offset bend and a second offset bend and a step portion between the offset bends, the distal end having a cored head portion and a retaining tab, a handle plate having a retaining slot for receiving the retaining tab, a lock lever member having a proximal end portion and a distal end portion, the lock lever member having a first offset bend, a second offset bend, and a step portion between the offset bends, and a pivotal connection for connecting the lock lever member within the primary handle bar.

In another embodiment of the present disclosure, a composite handle assembly comprises a primary handle bar having a proximal end portion and a distal end portion, the primary handle bar having a first offset bend and a second offset bend and a step portion between the offset bends, the distal end having a cored head portion and a retaining tab, a washer, a handle plate having a retaining slot for receiving the retaining tab and an annular space for receiving the washer, a lock lever member having a proximal end portion and a distal end portion, the lock lever member having a first offset bend, a second offset bend, and a step portion between the offset bends, and a pivotal connection for connecting the lock lever member within the primary handle bar.

In yet another embodiment, a composite handle assembly comprises a primary handle bar having a proximal end portion and a distal end portion, the primary handle bar having a first offset bend and a second offset bend and a step portion between the offset bends, the distal end having a cored head portion, a socket opening, and a retaining tab, a handle plate having a retaining slot for receiving the retaining tab, a lock lever member having a proximal end portion and a distal end portion, the lock lever member having a first offset bend, a second offset bend, and a step portion between the offset bends, the distal end portion having a lock lever plate having a plurality of lock lever notches with intervening teeth there between, and a pivotal connection for connecting the lock lever member within the primary handle bar.

The composite valve handle of this invention will be made of various formulas of polymers, whether it be polypropylene, or can be fabricated of nylon, or any related types of materials, generally that will add to the light weight of the handle during its installation, handling, and during its functioning. Other types of polymers may be used for the fabrication of the composite handle.

More preferably, the composite handle material as designed is nylon, with a 50% glass fiber reinforcement. The handle could be designed to use a range of materials and reinforcements, for example, other versions of nylon, such as Nylon 6/6, Nylon 6/10, Nylon 6/12, Nylon 4/6, polypropylene, as noted, in addition to polycarbonate, ABS, and PET. The reinforcement is used to increase the strength and rigidity of the parts. Glass fiber, both long fiber and short fiber, are available as well as aramid fiber, carbon fiber, and stainless steel. These will all provide a type of composite handle that is lighter weight, durable, and longer lasting, as stated.

Within the handle, also, may be located a RSID sensor, with the purpose of the sensor in the handle or in the handle plate provided to monitor if the valve has stayed closed, during application. The use of composite material for the handle makes the RFID more practical because there is not the shielding from the metal of prior art type of handles. Other sensors could be used in place of the RFID. For example, a magnet can be embedded in the handle, and a magnetic sensitive switch can be in the handle plate. A contact switch could be used as well. All switches would be monitored and data stored for when the valves were opened to provide an audit of the trailer.

It should be recognized that the present disclosure provides a composite handle assembly that provides for easy and convenient remote operation of a butterfly valve.

The present disclosure is also directed to a composite handle assembly that can be positioned at a desired angular orientation relative to a tank trailer or a butterfly valve.

The present disclosure provides a composite handle assembly that is easy to operate with use of a handle.

The present disclosure also provides a composite handle assembly that provides a more convenient position to secure a handle for operating or maneuvering a butterfly valve between a loading and unloading positions.

The present disclosure is further directed to a composite handle assembly that is constructed of a composite material that is dissimilar to the material that a butterfly valve is constructed of so that the composite handle assembly will not corrode to the butterfly valve.

The present disclosure is directed to a composite handle assembly that makes it far more convenient and safer to use a handle to operate a butterfly valve between a loading and unloading position.

The present disclosure is also directed to a composite handle assembly that provides greater clearance from the tank trailer operating structures in the vicinity of the butterfly valve, through the use of the composite handle assembly that extends comfortably away from the butterfly valve and it also constructed to furnish clearance to other components associated with a tank trailer.

The present disclosure is further directed to a composite handle assembly that may be constructed with a composite material that is strong and will resist impact from flying rocks and other debris during transportation or use.

The present disclosure is also directed to a composite handle assembly that includes a washer or dust shield for preventing any contaminants from interfering with the use of the composite handle assembly.

These and other advantages of the present disclosure will become apparent to those skilled in the art after considering the following detailed specification in conjunction with the accompanying drawings.

### BRIEF DESCRIPTION OF THE DRAWINGS

FIG. 1 is a side view of a composite handle assembly constructed according to the present disclosure installed on a product discharge valve of a tank trailer;

FIG. 2 is a top view of the composite handle assembly constructed according to the present disclosure attached to product discharge valve;

FIG. 3 is a partial bottom view of a handle plate of the composite handle assembly constructed according to the present disclosure with a washer installed;

FIG. 4 is a partial bottom view of the handle plate of the composite handle assembly constructed according to the present disclosure with the washer removed;

FIG. 5 is a partial cross-sectional view of the handle plate of the composite handle assembly with the washer installed with the cross-sectional view being taken along the plane of line 5-5 of FIG. 3;

FIG. 6 is a bottom view of a handle plate of the composite handle assembly with the washer removed;

FIG. 7 is a front perspective view of a handle plate of the composite handle assembly with the washer removed; and

FIG. 8 is a back perspective view of a washer of the composite handle assembly constructed according to the present disclosure.

### DETAILED DESCRIPTION OF A PREFERRED EMBODIMENT

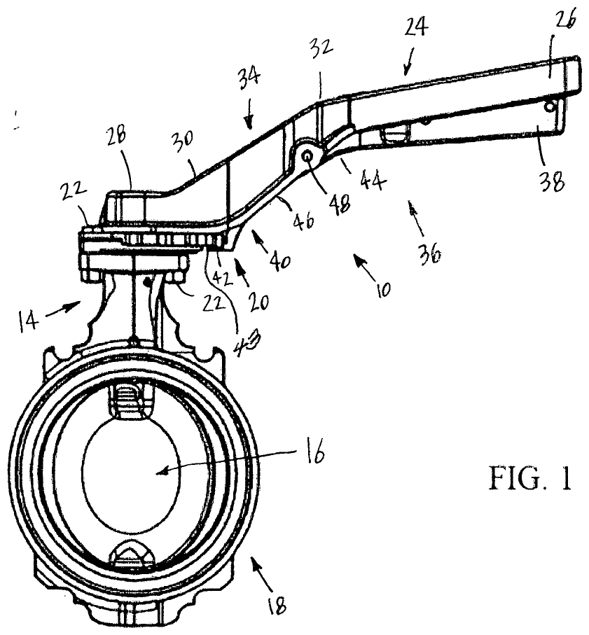

Referring now to the drawings, wherein like numbers refer to like items, number 10 identifies a preferred embodiment of a composite handle assembly constructed according to the present disclosure. With reference now to FIG. 1, the composite handle assembly 10 is shown attached to a valve stem 14 of a butterfly valve 16. The butterfly valve 16 may be opened by operation of the valve stem 14 to allow the contents (not shown) of a tank trailer to be unloaded from the tank trailer valve 18 with the use of a pressurized air piping system (not shown). The composite handle assembly 10 has a handle plate 20 which is connected to the butterfly valve 16 by use of a pair of bolts 22. The composite handle assembly 10 is used to move or pivot the internal valve stem 14 which in turn opens or closes the butterfly valve 16. The composite handle assembly 10 may be moved in a desired angle or orientation such as in a range of 0° to 90°. The composite handle assembly 10 may be constructed of any suitable composite material.

The composite handle assembly 10 comprises a primary handlebar 24 having a proximal end portion 26 and a distal end portion 28. The primary handlebar 24 also has a first offset bend 30 and a second offset bend 32 and a step portion 34 between the offset bends 30 and 32. The primary handlebar 24 may be long so that an individual can easily grasp the assembly 10 when the assembly 10 is connected to the handle plate 20. The composite handle assembly 10 also comprises a lock lever member 36 having a proximal end portion 38 and a distal end portion 40. The lock lever member 36 also has a first offset bend 42, a second offset bend 44, and a step portion 46 between the offset bends 42 and 44. A pivotal connection 48 is used to connect the lock lever member 36 within the primary handlebar 24. The bar 24 and the lock lever member 36 may be reinforced by use of internal bracing or diagonal bracing, both of which are not shown. The bracing adds structural reinforcement to the bar 24 and the member 36 to assure longevity of usage. It should be noted that the composite handle assembly 10 is normally located beneath the tank trailer 18 and is subject to flying rocks and other debris that the tank trailer 18 may encounter during transportation and reinforcement is desired. Further, the composite material that the assembly 10 is made from should be strong and durable to withstand flying rocks and other debris.

An RFID sensor may be applied, as at 43, as noted in FIG. 1, in order to provide an indication as to whether that the valve has stayed closed, after its manipulation of the butterfly valve into closure.

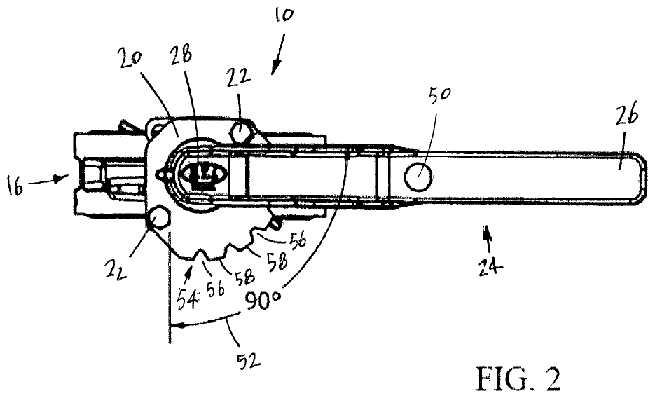

FIG. 2 illustrates a top view of the composite handle assembly 10 connected by the handle plate 20 to the butterfly valve 16 by the use of the bolts 22. The composite handle assembly 10 is shown to have the primary handlebar 24 having the proximal end portion 26 and the distal end portion 28. The primary handlebar 24 may have an insert 50 that snaps into the bar 24. The insert 50 may be color coded to identify the particular valve function. As can be appreciated, the composite handle assembly 10 is capable of rotating the butterfly valve 16 through an arc of 90°, as depicted by an arc line 52. The distal end portion 28 has a lock lever plate 54 having a plurality of lock lever notches 56 with intervening teeth 58 there between. The bolts 22 also serve as stops or limits for the rotation of the composite handle assembly 10. Although not shown in any detail, it is possible that the composite handle assembly 10 may include other structure such as a spring composite lever tip (not shown) that may interact with the notches 56 to further facilitate operation of the composite handle assembly 10. Optionally, the lock lever plate 54 may include a ratcheting mechanism, including a ratcheting reversal feature, to prevent the composite handle assembly 10 from prematurely or accidentally reversing operation of the butterfly valve 16.

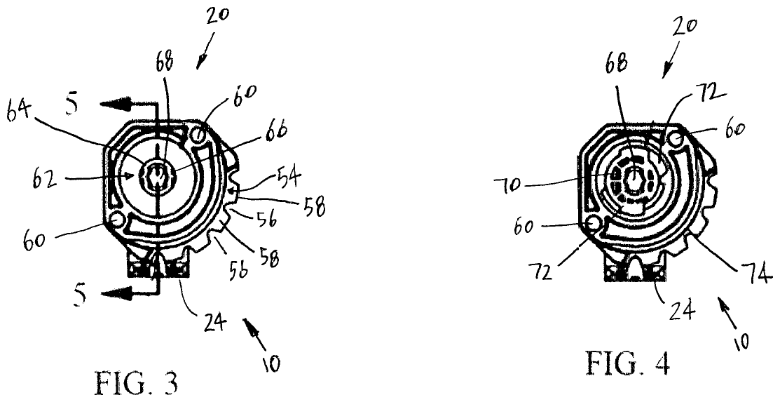

With particular reference now to FIG. 3, a partial bottom view of the handle plate 20 of the composite handle assembly 10 is depicted. The handle plate 20 has a pair of bolt apertures 60 where are adapted for receiving the bolts 22. A washer or dust shield 62 is installed or pressed into place in an annular space 64 in the handle plate 20 to seal out dust or other contamination that can enter into the handle plate 20. The washer 62 has a central opening 66 that allows the valve stem 14 to pass there through. The primary handlebar 24 has a socket opening 68 for receiving the valve stem 14. The socket opening 68 will be configured similarly to the shape or configuration of the valve stem 14. The lock lever plate 54 having the plurality of lock lever notches 56 with the intervening teeth 58 there between is also shown being part of the handle plate 20.

FIG. 4 illustrates a partial bottom view of the handle plate 20 of the composite handle assembly 10 with the washer 62 removed and the handle plate 20 being connected to the distal end portion 28 of the primary handlebar 24. The primary handlebar 24 has a cored head portion 70 which is provided to improve the injection molding process time when manufacturing the primary handlebar 24 of the composite handle assembly 10. The handle plate 20 also has retaining slots 72 for receiving and retaining the distal end portion 28 of the primary handlebar 24 in place, as will be explained more fully herein. The handle plate 20 is also shown having the bolt apertures 60 and the annular space 64 which is used for receiving the washer 62. Again, the lock lever plate 54 having the plurality of lock lever notches 56 with the intervening teeth 58 there between is also shown being part of the handle plate 20. The handle plate 20 has a rounded tip 74 that skates on the teeth 58 of the plate 20.

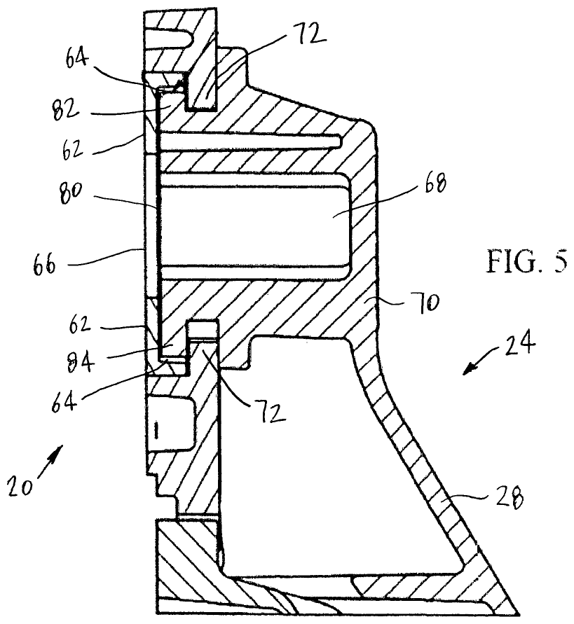

Referring now to FIG. 5, a partial cross-sectional view of the handle plate 20 of the composite handle assembly 10 with the washer 62 installed in the annular space 64. The washer 62 is retained in place in the annular space 64 formed in the handle plate 20. The distal end portion 28 of the primary handlebar 24 is shown having the cored head portion 70. The handle plate 20 also has an opening 80 adjacent to the central opening 66 of the washer 62. The distal end portion 28 of the primary handlebar 24 has tabs 82 and 84 for mating with the retaining slots 72 of the handle plate 20 to connect or lock the handle plate 20 to the primary handlebar 24. The central opening 66 of the washer 62, which is aligned with the socket opening 68 of the bar 24, are also shown and are provided for receiving the valve stem 14 (not shown).

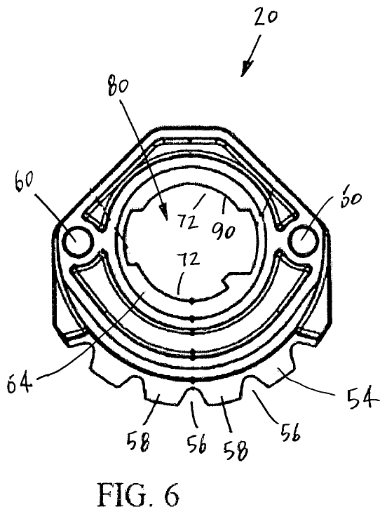

FIG. 6 is a bottom view of the handle plate 20 of the composite handle assembly 10 with the washer 62 removed and the plate 20 not being attached to the primary handlebar 24. The handle plate 20 has the retaining slots 72 positioned around a periphery edge 90 of the opening 80. The opening 80 is provided for allowing the valve stem 14 to pass there through for the valve stem 14 to fit within or be captured by the socket opening 68 (FIG. 5). The handle plate 20 is also shown having the pair of bolt openings 60, the annular space 64, the lock lever plate 54, the lock lever notches 56, and the teeth 58.

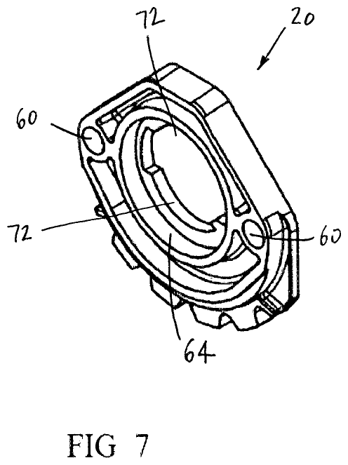

With particular reference now to FIG. 7, a side perspective view of the handle plate 20 is illustrated. The handle plate 20 is shown having the annular space 64 that is adapted for receiving the washer 62. The washer 62 may snap in place into the space 64. The washer 62 will prevent contaminants from getting into the opening 80, the cored head portion 70, and the socket opening 68. The bolt openings 60 and the retaining slots 72 are also shown.

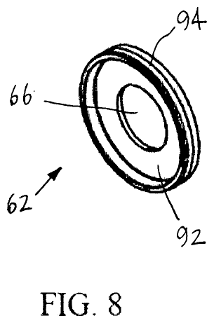

FIG. 8 is a perspective view of the washer 62. The washer 62 has the central opening 66 that allows the valve stem 14 to pass there through, a top circular portion 92, and a periphery rim portion 94 that extends from the top circular portion 92. The periphery rim portion 94 fits into the annular space G4 of the handle plate 20.

As can be appreciated, the composite handle assembly 10 is attached to the butterfly valve 16 to be used to open or close the butterfly valve 16. Once attached, the composite handle assembly 10 extends out from the valve 16 at a comfortable position and location. An operator of the assembly 10 will be able to easily grasp the bar 24 to rotate or operate the butterfly valve 16. The lock lever member 36 can also be easily grasped to operate the lock lever plate 54. Once the composite handle assembly 10 is operated, the butterfly valve 16 may be opened to unload product from the tank trailer 18. Upon the product being emptied from the tank trailer 18, the composite handle assembly 10 may be rotated in the opposite direction to close the butterfly valve 16.

From all that has been said, it will be clear that there has thus been shown and described herein a composite handle assembly. It will become apparent to those skilled in the art, however, that many changes, modifications, variations, and other uses and applications of the subject composite handle assembly are possible and contemplated. All changes, modifications, variations, and other uses and applications which do not depart from the spirit and scope of the disclosure are deemed to be covered by the disclosure, which is limited only by the claims which follow.

What is claimed is:

1. A composite handle assembly comprising:
a primary handlebar having a proximal end portion and a distal end portion, the primary handlebar having a first offset bend and a second offset bend and a step portion between the offset bends, the distal end having a cored head portion and a retaining tab;
a handle plate having a retaining slot for receiving the retaining tab;
a lock lever member having a proximal end portion and a distal end portion, the lock lever member having a first offset bend, a second offset bend, and a step portion between the offset bends; and
a pivotal connection for connecting the lock lever member within the primary handlebar.

2. The composite handle assembly of claim 1 wherein the primary handlebar, the handle plate, and the lock lever member are comprised of a composite material.

3. The composite handle assembly of claim 1 wherein the primary handlebar may be pivoted between 0° and 90°.

4. The composite handle assembly of claim 1 wherein the handle plate further comprises a pair of bolt openings for receiving a pair of bolts for attaching the handle plate to a butterfly valve.

5. The composite handle assembly of claim 1 wherein the handle plate is connected to the primary handlebar through the use of the retaining tab and the retaining slot.

6. The composite handle assembly of claim 1 wherein the primary handlebar further comprises an insert that snaps into the primary handlebar.

7. The composite handle assembly of claim 6 wherein the insert is color coded to identify a particular valve function.

8. A composite handle assembly comprising:
a primary handlebar having a proximal end portion and a distal end portion, the primary handlebar having a first offset bend and a second offset bend and a step portion between the offset bends, the distal end having a cored head portion and a retaining tab;
a washer;
a handle plate having a retaining slot for receiving the retaining tab and an annular space for receiving the washer;
a lock lever member having a proximal end portion and a distal end portion, the lock lever member having a first offset bend, a second offset bend, and a step portion between the offset bends; and
a pivotal connection for connecting the lock lever member within the primary handlebar.

9. The composite handle assembly of claim 8 wherein the primary handlebar, the handle plate, and the lock lever member are comprised of a composite material.

10. The composite handle assembly of claim 8 wherein the primary handlebar may be pivoted between 0° and 90°.

11. The composite handle assembly of claim 8 wherein the washer comprises a top circular portion having a central opening, and a periphery rim portion that extends from the top circular portion.

12. The composite handle assembly of claim 11 wherein the periphery rim portion fits into the annular space.

13. The composite handle assembly of claim 8 wherein the handle plate further comprises a pair of bolt openings for receiving a pair of bolts for attaching the handle plate to a butterfly valve.

14. The composite handle assembly of claim 8 wherein the handle plate is connected to the primary handlebar through the use of the retaining tab and the retaining slot.

15. The composite handle assembly of claim 8 wherein the primary handlebar further comprises an insert that snaps into the primary handlebar.

16. A composite handle assembly comprising:
a primary handlebar having a proximal end portion and a distal end portion, the primary handlebar having a first offset bend and a second offset bend and a step portion between the offset bends, the distal end having a cored head portion, a socket opening, and a retaining tab;
a handle plate having a retaining slot for receiving the retaining tab;
a lock lever member having a proximal end portion and a distal end portion, the lock lever member having a first offset bend, a second offset bend, and a step portion between the offset bends, the distal end portion having a lock lever plate having a plurality of lock lever notches with intervening teeth there between; and
a pivotal connection for connecting the lock lever member within the primary handlebar.

17. The composite handle assembly of claim 16 wherein the primary handlebar, the handle plate, and the lock lever member are comprised of a composite material.

18. The composite handle assembly of claim 16 wherein the primary handlebar may be pivoted between 0° and 90°.

19. The composite handle assembly of claim 16 wherein the washer comprises a top circular portion having a central opening, and a periphery rim portion that extends from the top circular portion.

20. The composite handle assembly of claim 19 wherein the periphery rim portion fits into the annular space.

21. The composite handle assembly of claim 1, wherein the composite handle may be fabricated of a polymer material.

22. The composite handle assembly of claim 21, wherein the polymer material may be a polypropylene.

23. The composite handle assembly of claim 21, wherein the composite material forming the handle may be nylon.

24. The composite handle assembly of claim 1, and including a sensor provided with a handle plate to indicate when the handle has turned the butterfly valve into closure, and that the butterfly valve remains in closure.
